(19) United States
(12) Patent Application Publication
(10) Pub. No.: US 2026/0088402 A1
(43) Pub. Date: Mar. 26, 2026

(54) MULTILAYER FILM FOR SECONDARY BATTERY POUCH AND A POUCH-TYPE SECONDARY BATTERY USING THE SAME

(71) Applicant: DONGWON SYSTEMS CORPORATION, Seoul (KR)

(72) Inventors: Eui Hwan SONG, Seoul (KR); Sung Gi YOON, Cheonan-si (KR); Hyun Ah LEE, Sejong-si (KR); Gyu Woon JUNG, Ansan-si (KR); Jong An KIM, Sejong-si (KR); Seong Weon JANG, Suwon-si (KR); Seung Hyeon YEON, Bucheon-si (KR); Hyeong Hoon KIM, Suwon-si (KR)

(73) Assignee: DONGWON SYSTEMS CORPORATION, Seoul (KR)

(21) Appl. No.: 19/049,342

(22) Filed: Feb. 10, 2025

(30) Foreign Application Priority Data
Sep. 23, 2024 (KR) 10-2024-0128155

(51) Int. Cl. H01M 50/129; H01M 50/105; H01M 50/119; H01M 50/121; H01M 50/131; H01M 50/133; H01M 50/178

(52) U.S. Cl. CPC H01M 50/129; H01M 50/105; H01M 50/119; H01M 50/121; H01M 50/131; H01M 50/133; H01M 50/178

(57) ABSTRACT

A multilayer film for a secondary battery pouch housing an electrode assembly having a lead tab portion therein. The multilayer film for the pouch includes an outer layer; a metal layer; and a sealing layer, wherein the outer layer, the metal layer and the sealing layer are sequentially stacked, wherein the lead tab portion comprises a lead tab and a tab film provided on at least a portion of the lead tab, wherein the lead tab portion is heat-fused with the multilayer film for the pouch, wherein the tab film is interposed between the sealing layer and the lead tab and is heat-fused, wherein a room temperature upper yield point, which is a sealing strength obtained by a tensile test of the heat-fused sealing layer and lead tab portion at room temperature, is 100 N/15 mm or more, and a room temperature lower yield point is 50 N/15 mm or more.

### CROSS-REFERENCE TO RELATED APPLICATIONS

This application claims the benefit of Korean Application No. 10-2024-0128155, filed Sep. 23, 2024, in the Korean Intellectual Property Office. All disclosures of the document named above are incorporated herein by reference.

### TECHNICAL FIELD

The present invention relates to a multilayer film for a secondary battery pouch and a pouch-type secondary battery using the same, and more specifically, to a multilayer film for a secondary battery pouch having improved sealing properties with a lead tab and a pouch-type secondary battery using the same.

### BACKGROUND ART

Recently, the use of energy sources to replace chemical fuels has been increasing, and among them, lithium secondary batteries are being used in various ways because they convert chemical energy into electrical energy, have a high energy density, and can be reused through multiple charging and discharging cycles. Lithium secondary batteries enable miniaturization and weight reduction of devices, and are not only used as core components that power IT devices for mobile communications and electric vehicles, but also as power sources for portable electronic devices used in modern people's daily lives.

These lithium secondary batteries comprise a cathode, an anode, an electrolyte, a separator, and an outer body that packages them. The outer body uses cylindrical cans, square cans, pouches, etc., and among them, pouches have the advantage of being easy to form into various shapes, so they are used in various ways.

On the other hand, as lithium secondary batteries become more capable of holding high capacities, the stability of lithium secondary batteries is also being considered, and various studies are being conducted to improve the properties of pouches.

(Related Art) Japanese Patent Application Publication No. 2005-183820

### DISCLOSURE

### Technical Issues

The purpose of the present invention is to provide a multilayer film for a secondary battery pouch with improved lead tabs and sealing strength, and a pouch-type secondary battery using the same.

In addition, another purpose of the present invention is to provide a multilayer film for a secondary battery pouch with improved safety in which a short circuit, etc. does not occur in the secondary battery even when multiple charging and discharging are performed, and a pouch-type secondary battery using the same.

### Technical Solution

According to one aspect of the present invention, embodiments of the present invention comprise a multilayer film for a secondary battery pouch and a pouch-type secondary battery using the same.

In an embodiment, a multilayer film for a secondary battery pouch housing an electrode assembly having a lead tab portion therein comprises an outer layer; a metal layer; and a sealing layer, wherein the outer layer, the metal layer and the sealing layer are sequentially stacked, wherein the lead tab portion comprises a lead tab and a tab film provided on at least a portion of the lead tab, wherein the lead tab portion is heat-fused with the multilayer film for the pouch, wherein the tab film is interposed between the sealing layer and the lead tab and is heat-fused, wherein a room temperature upper yield point, which is a sealing strength obtained by a tensile test of the heat-fused sealing layer and lead tab portion at room temperature, is 100 N/15 mm or more, and a room temperature lower yield point is 50 N/15 mm or more.

In an embodiment, the room temperature upper yield point is 100 N/15 mm to 180 N/15 mm, and the room temperature lower yield point is 50 N/15 mm to 90 N/15 mm.

In an embodiment, a high temperature upper yield point, which is the maximum sealing strength of the heat-fused sealing layer and the lead tab portion at 60° C., is 90 N/15 mm or more, and a high temperature lower yield point is 50 N/15 mm or more

In an embodiment, the high temperature upper yield point is 90 N/15 mm to 150 N/15 mm, and the high temperature lower yield point is 50 N/15 mm to 90 N/15 mm.

In an embodiment, the melting temperature (Tm) of the sealing layer is 80° C. to 180° C.

In an embodiment, the sealing layer is formed by extruding at least one of polypropylene (PP) and an ethylene-propylene copolymer, and the thickness of the sealing layer is 30 μm to 150 μm.

In an embodiment, the sealing layer contacts one side and the other side of the lead tab portion, respectively, and the total contact area of the one side and the other side of the lead tab portion and the sealing layer is 25 mm² to 1000 mm².

In an embodiment, a heat-fusing condition of the sealing layer and the lead tab portion is performed at 3.0 sec, 0.04 MPa, and 190° C. using a sealing bar having a length of 85 mm and width of 7 mm, and the sealing strength is obtained by measuring with a sealing strength measuring device at test speed of 20 mm/min and Grip Gap of 30 mm.

In an embodiment, the thickness of the lead tab is 300 μm to 1000 μm, and the width of the lead tab is 5 mm to 100 mm.

In an embodiment, the sealing layer comprises a first thickness in contact with one surface of the lead tab portion and a second thickness in contact with the other surface of the lead tab portion, and the total thickness of the first thickness and the second thickness is 140 μm to 300 μm, and thickness of the lead tab with respect to the total thickness is 200% to 500%.

In an embodiment, the outer layer is at least one of nylon, polyethylene terephthalate (PET), polybutylene terephthalate (PBT), and polyethylene, and the metal layer comprises aluminum and iron, and the iron is 0.01 wt % to 2 wt %.

In an embodiment, a pouch-type secondary battery comprising a secondary battery pouch including the above-mentioned multilayer film comprises an electrode assembly including a positive electrode, a negative electrode, and a separator, and having at least one lead tab portion protruding outward; a storage portion for storing the electrode assembly; and a heat-fusing portion in contact with at least a portion of the lead tab portion.

In an embodiment, the multilayer film comprises a sealing layer, a metal layer, and an outer layer, and the secondary battery pouch comprises an upper surface and a lower surface made of the multilayer film, and the upper surface and the lower surface are composed of a pair and each comprises a heat-fusing portion, and the heat-fusing portion is connected to an edge of the storage portion.

In an embodiment, the heat-fusing portion has a width of 3 mm to 10 mm, and the lead tab portion comprises a lead tab and a tab film provided on at least a portion of the lead tab, and the lead tab portion is drawn out to an outside of the secondary battery pouch through the heat-fusing portion.

In an embodiment, the heat-fusing portion and the lead tab portion are heat-fused, and a room temperature upper yield point, which is a sealing strength obtained by a tensile test at room temperature, is 100 N/15 mm or more, and a room temperature lower yield point is 50 N/15 mm or more.

### Advantageous Effects

According to the present invention as described above, a multilayer film for a secondary battery pouch having high sealing strength and a lead tab stably fixed thereto and a pouch-type secondary battery using the same can be provided.

In addition, according to the present invention, a multilayer film for a secondary battery pouch that can be easily used in a high-capacity secondary battery and a pouch-type secondary battery using the same can be provided.

### DESCRIPTION OF DRAWINGS

These and/or other aspects will become apparent and more readily appreciated from the following description of the embodiments, taken in conjunction with the accompanying drawings in which:

FIG. 1 is a schematic drawing of a pouch-type secondary battery according to an embodiment of the present invention;

FIG. 2 is a drawing of the pouch-type secondary battery of FIG. 1;

FIG. 3 is a cross-sectional view showing the lead tab portion and the multilayer film for the pouch of FIG. 1;

FIG. 4 is a drawing showing the results of measuring the sealing strength according to an embodiment of the present invention;

FIG. 5 is a schematic drawing of a lead tab portion and a sealing layer according to an embodiment of the present invention;

FIG. 6 is a drawing showing a peeling interface after measuring the peeling strength of Examples 1 and 2 and Comparative Example 1 at room temperature;

FIG. 7 is a graph showing the sealing strength of the lead tab portion and the sealing layer of Examples 1 and 2 at room temperature;

FIG. 8 is a graph showing the sealing strength of the lead tab portion and the sealing layer of Comparative Examples 1 to 6 at room temperature;

FIG. 9 is a drawing showing the peeling interface after measuring the peeling strength of Examples 3 and 4 at a high temperature (60° C.);

FIG. 10 is a graph showing the sealing strength of the lead tabs and sealing layers of Examples 3 and 4 at a high temperature (60° C.); and

FIG. 11 is a graph showing the sealing strength of the lead tabs and sealing layers of Comparative Examples 7 to 12 at a high temperature (60° C.).

### DETAILED DESCRIPTION OF EMBODIMENTS

Specific details of other embodiments are included in the detailed description and drawings.

The advantages and features of the present invention, and the methods for achieving them, will become apparent by referring to the embodiments described in detail below together with the accompanying drawings. However, the present invention is not limited to the embodiments disclosed below, but can be implemented in various forms, and unless otherwise specified in the following description, all numbers, values, and/or expressions expressing components, reaction conditions, and contents of components in the present invention should be understood as being modified by the term “about” in all cases, since such numbers are approximations that reflect various uncertainties of measurement that occur in obtaining such values, among other things. In addition, when a numerical range is disclosed in this description, such range is continuous and includes all values from the minimum value to the maximum value inclusive, unless otherwise indicated. Furthermore, when such a range refers to an integer, unless otherwise indicated, all integers from the minimum value up to and including the maximum value are included.

In addition, when a range is described for a variable in the present invention, it will be understood that the variable includes all values within the described range including the described endpoints of the range. For example, a range of “5 to 10” will be understood to include not only the values 5, 6, 7, 8, 9, and 10, but also any subranges such as 6 to 10, 7 to 10, 6 to 9, 7 to 9, etc., and also any values between integers that fall within the scope of the described range, such as 5.5, 6.5, 7.5, 5.5 to 8.5, and 6.5 to 9. For example, a range of “10% to 30%” will be understood to include not only values such as 10%, 11%, 12%, 13%, and all integers up to and including 30%, but also any subranges such as 10% to 15%, 12% to 18%, 20% to 30%, and any value between reasonable integers within the stated ranges, such as 10.5%, 15.5%, 25.5%, etc.

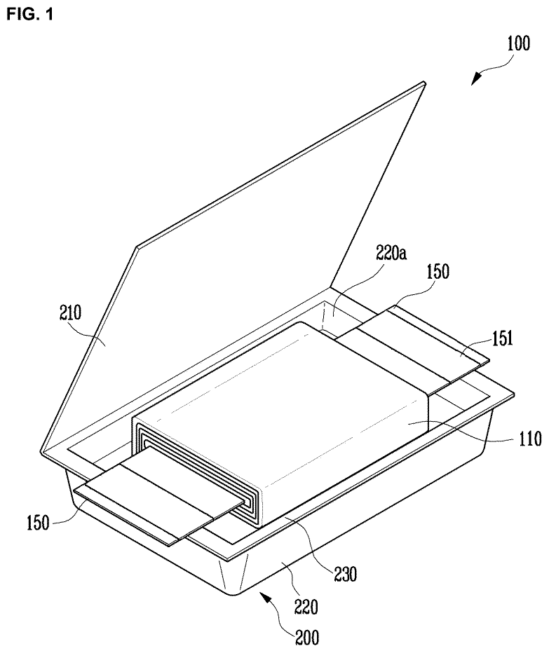

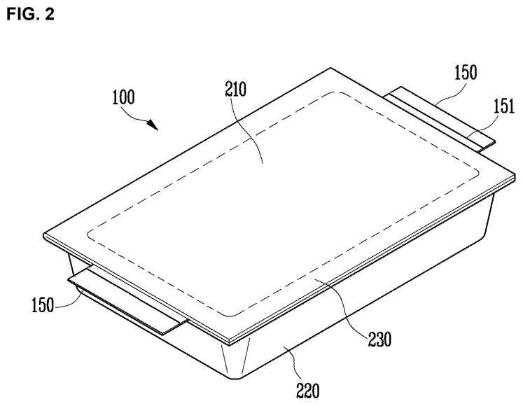

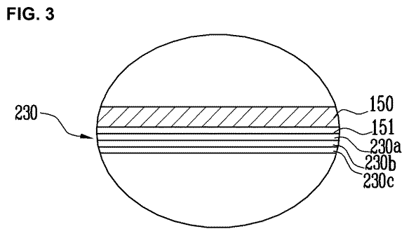

FIG. 1 is a schematic diagram illustrating a pouch-type secondary battery according to an embodiment of the present invention. FIG. 2 is a diagram illustrating the pouch-type secondary battery of FIG. 1. FIG. 3 is a cross-sectional view illustrating a lead tab portion and a multilayer film for a pouch of FIG. 1.

Referring to FIGS. 1 and 2, a pouch-type secondary battery 100 according to an embodiment of the present invention comprises an electrode assembly 110 having a lead tab portion 150, 151 and a secondary battery pouch 200 storing the electrode assembly 110 therein, and the secondary battery pouch 200 may be formed of a multilayer film for a pouch.

The secondary battery pouch 200 may be formed by having the multilayer film for the pouch as an upper surface 210 and a lower surface 220, and the lower surface 220 has a storage portion 220a, which is a space formed by being concavely formed to accommodate the electrode assembly 110 therein, and after the electrode assembly 110 is accommodated in the space 220a, the upper surface 210 is provided, and the upper surface 210 and the lower surface 220 may be sealed by heat-fusing. Hereinafter, in this embodiment, the secondary battery pouch 200 is described in which the storage portion 220a is provided on the lower surface 220, but the storage portion 220a may be formed in various ways, such as being formed on the upper surface 210, or being formed on both sides of the upper surface 210 and the lower surface 220, and is not limited to FIG. 1.

In the secondary battery pouch 200, the upper surface 210 and the lower surface 220 may be sealed by heat-fusing to form a heat-fusing portion 230. The heat-fusing portion 220 may be formed on an edge to surround the storage portion 220a. The lead tab 150 of the electrode assembly 110 may be drawn out to the outside of the secondary battery pouch 200 by passing through the heat-fusing portion 220.

Referring to FIG. 3, the secondary battery pouch 200 is formed of the multilayer film, and the multilayer film may sequentially comprise an outer layer 230c, a metal layer 230b, and a sealing layer 230a. In the multilayer film, the sealing layer 230a may be thermally fused to the lead tab portion 150, 151 and come into close contact therewith. The sealing strength obtained by a tensile test at room temperature of the thermally fused sealing layer 230a and a lead tab portion 150, 151 may have a room temperature upper yield point of 100 N/15 mm or more, and a room temperature lower yield point of 50 N/15 mm or more.

The lead tab portion 150, 151 may comprise a lead tab 150 and a tab film 151 provided on at least a portion of the lead tab 150. The lead tab portion 150, 151 may be heat-fused with the multilayer film for the pouch, and the tab film 151 may be interposed between the sealing layer 230a and the lead tab 150 to be heat-fused.

The lead tab 150 may be provided with a metal such as nickel, and the tab film 151 may be provided with a polymer such as polyimide to surround the lead tab 150. The tab film 151 may be interposed between the lead tab 150 and the sealing layer 230a, thereby preventing a short circuit, etc., from occurring between the metal layer 230b of the multilayer film and the lead tab 150 during a heat-fusing process in which heat is applied and pressure is applied. The tab film 151 may be provided with a thickness reduced by approximately 80% after performing a heat-fusing process.

Usually, in a pouch-type secondary battery, an electrolyte is stored together with the electrode assembly inside the pouch, and a lead tab is drawn out to the outside of the pouch to be electrically connected to the outside. At this time, the pouch should be made of an insulating material so that the electrode assembly provided inside does not short-circuit, and should be sealed to prevent leakage of the electrolyte, and at the same time, should have high chemical resistance to the electrolyte made of a chemical substance. In addition, the interfacial adhesive strength between the lead tab made of a metal such as aluminum and the sealing layer made of a polymer is low because they are made of different materials, which has been a problem.

On the other hand, the multilayer film for a secondary battery pouch according to an embodiment of the present invention improves the sealing strength between the lead tab portion 150, 151 and the sealing layer 230a, while at the same time, the sealing layer 230a has high chemical resistance, thereby preventing the bonding strength between the sealing layer 230a and the lead tab portion 150, 151 from being reduced due to an electrolyte. In addition, the multilayer film for a secondary battery pouch according to an embodiment of the present invention can exhibit high sealing strength with the lead tab portion 150, 151 not only at room temperature but also at high temperatures.

The outer layer 230c is provided on the outermost surface of the secondary battery pouch 200 to protect the secondary battery pouch 200 from external pressure, etc., and provide insulation properties to enable stable use of the secondary battery. The outer layer 230c may be made of at least one of nylon, polyethylene terephthalate (PET), polybutylene terephthalate (PBT), and polyethylene. Specifically, the outer layer 230c may be made of one or more layers, and may be made of polyethylene terephthalate PET and nylon in sequence from the outside, and polyethylene terephthalate (PET) may be provided on the outermost surface of the secondary battery pouch 200.

The thickness of the outer layer 230c may be 20 [symbol] to 80 [symbol] . When the outer layer 230c is made of polyethylene terephthalate (PET) and nylon, the thickness of the nylon may be thicker than the thickness of the polyethylene terephthalate (PET). Specifically, the thickness of the nylon may be thicker by about 1 [symbol] to 20 [symbol] than the thickness of the polyethylene terephthalate (PET). By providing the polyethylene terephthalate (PET) and nylon in the above-described range in the outer layer 230c, the mechanical strength of the secondary battery pouch 200 can be improved and the metal layer 230b can be effectively insulated without unnecessarily increasing the thickness of the outer layer 230c.

The metal layer 230b is provided in the central layer of the secondary battery pouch 200 to provide a predetermined mechanical strength to the secondary battery pouch 200, while providing formability so that the secondary battery pouch 200 can accommodate the electrode assembly 110 and maintain the shape of the secondary battery pouch 200. The metal layer 230b comprises aluminum and iron, and the iron may be in an amount of 0.01 wt % to 2 wt %. If the iron in the metal layer 230b is less than 0.01 wt %, the ductility of the metal layer deteriorates, and if it exceeds 2 wt %, the formability of the metal layer deteriorates. Specifically, the metal layer 230b is mostly made of aluminum, but may contain a trace amount of iron, and the iron may be 0.01 wt % to 1.5 wt %, or 0.05 wt % to 1.5 wt %, or 0.05 wt % to 1.2 wt %, or 0.1 wt % to 1.2 wt %.

The metal layer 230b may have a thickness of 20 [symbol] to 70 [symbol] . If the thickness of the metal layer 230b is less than 20 [symbol] , problems such as tearing may occur during the process of forming the secondary battery pouch 200, and if it exceeds 70 [symbol] , the formability deteriorates and the flexible properties of the secondary battery pouch 200 deteriorate, which is a problem. Specifically, the thickness of the metal layer 230b may be 20 [symbol] to 65 [symbol] , or 30 [symbol] to 65 [symbol] . Specifically, the thickness of the metal layer 230b may be 60 [symbol] .

The sealing layer 230a may be provided on the inner surface of the secondary battery pouch 200, and may be heat-fused and sealed together with the lead tab portion 150, 151 while directly contacting the electrode assembly 110 and the electrolyte. The sealing layer 230a may be formed by extruding at least one of polypropylene (PP) and an ethylene-propylene copolymer, and may have a thickness of 30 [symbol] to 150 [symbol] . The extrusion may include bonding at least one of polypropylene and an ethylene-propylene copolymer to the metal layer 230b by an extrusion method.

If the thickness of the sealing layer 230a is less than 30 [symbol] , during the heat-fusing process, the lead tab 150, which is the metal part of the lead tab portion 150, 151, and the metal layer 230b, may come into contact, and a short circuit may occur or an electrolyte leak may occur during the subsequent electrical use process. In addition, if the thickness of the sealing layer 230a exceeds 150 [symbol] , the mechanical strength of the heat-fusing portion 230 formed by sealing the sealing layer 230b and the lead tab portion 150, 151 may be low, and the sealing strength may be reduced. Specifically, the thickness of the sealing layer 230a may be 30 [symbol] to 120 [symbol] , or 50 [symbol] to 120 [symbol] , or 50 [symbol] to 100 [symbol] , or 70 [symbol] to 90 [symbol] .

The melting temperature (Tm) of the sealing layer 230a may be 80° C. to 180° C. The melting temperature (Tm) of the sealing layer 230a refers to the melting temperature during the sealing process of the polymer film formed as the sealing layer 230a. The sealing layer 230a is provided with a melting temperature within the above-mentioned range, thereby having a predetermined mechanical strength and being effectively heat-fused with the lead tab portion 150, 151, so that the room temperature upper yield point and the room temperature lower yield point with respect to the lead tab portion 150, 151 may be provided within the above-mentioned range.

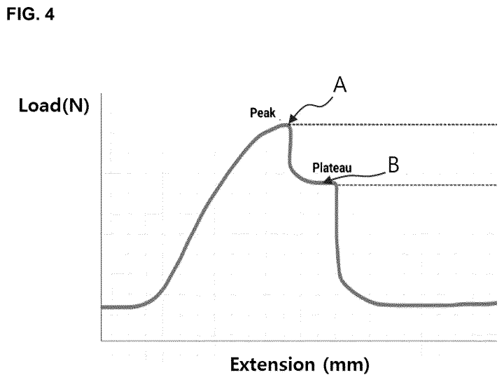

FIG. 4 is a drawing showing the results of measuring the sealing strength according to an embodiment of the present invention.

In the present embodiment, the room temperature upper yield point, which is the sealing strength obtained by a tensile test at room temperature of the heat-fused sealing layer 230a and a lead tab portion 150, 151, may be 100 N/15 mm or more, and the room temperature lower yield point may be 50 N/15 mm or more. The sealing strength may be obtained by providing the lead tab portion 150, 151 between two multilayer films, and then heat-fusing the sealing layer 230a and the lead tab portion 150, 151 to fix the lead tab portion 150, 151 between the sealing layers 230a. The heat-fusing conditions of the sealing layer 230a and the lead tab portion 150, 151 may be performed at 3.0 seconds, 0.04 MPa, and 190° C. using a sealing bar having a length of 85 mm and a width of 7 mm. The sealing strength can be obtained by measuring at a test speed of 20 mm/min and a Grip Gap of 30 mm using a universal material testing machine (UTM). Specifically, the sealing layer 230a and the lead tab portion 150, 151 that are heat-fused to each other can be measured by fixing the heat-fused portion with the sealing bar and pulling the lead tab portion 150, 151.

When the sealing strength is measured, a graph such as FIG. 4 can be obtained. In this embodiment, the lead tab portion 150, 151 is sealed with high strength to the sealing layer 230a, and at the same time, if gas is filled inside the secondary battery pouch 200, self-venting can be performed, thereby preventing safety problems such as explosion of the secondary battery from occurring. In the embodiment of the present invention, the upper yield point (A) means the highest value in a graph such as FIG. 4, and the lower yield point (B) means the average value of a plateau region.

The room temperature upper yield point may be 100 N/15 mm or more, and the room temperature lower yield point may be 50 N/15 mm or more. If the room temperature upper yield point between the heat-fused lead tab portion 150, 151 and sealing layer 230a is less than 100 N/15 mm, the sealing strength may be low, which may be a problem, and if the room temperature lower yield point is less than 50 N/15 mm, the secondary battery pouch 200 may not be vented when gas is generated inside, which may be a problem. Specifically, the room temperature upper yield point may be 100 N/15 mm to 180 N/15 mm, and the room temperature lower yield point may be 50 N/15 mm to 90 N/15 mm.

In addition, the high temperature upper yield point, which is the maximum sealing strength at 60° C. of the heat-fused sealing layer 230a and lead tab portion 150, 151, may be 90 N/15 mm or more, and the high temperature lower yield point may be 50 N/15 mm or more. If the high temperature upper yield point is less than 90 N/15 mm, electrolyte leakage, etc. may occur in the secondary battery, and if the high temperature lower yield point is less than 50 N/15 mm, the secondary battery pouch 200 may not be vented at high temperatures, which may be a problem. Specifically, the high temperature upper yield point may be 90 N/15 mm to 150 N/15 mm, and the high temperature lower yield point may be 50 N/15 mm to 90 N/15 mm.

The sealing layer 230a contacts one side and the other side of the lead tab portion 150, 151, respectively, and the total contact area between the one side and the other side of the lead tab portion 150, 151 and the sealing layer 230a may be 25 mm² to 1000 mm². The thickness of the lead tab 150 may be 300 [symbol] to 1000 [symbol] , and the width of the lead tab 150 may be 5 mm to 100 mm.

Since the contact area of the sealing layer 230a and the lead tab 150 and the thickness and width of the lead tab 150 are provided within the above-described range, the sealing layer 230a and the lead tab portion 150, 151 have high sealing strength and at the same time, self-vent occurs when gas is filled inside, so that the safety of the secondary battery can be improved.

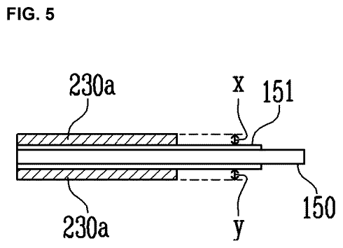

FIG. 5 is a drawing schematically showing a lead tab portion and a sealing layer according to an embodiment of the present invention. In FIG. 5, the metal layer and the outer layer laminated on the sealing layer 230a are omitted and shown. The sealing layer 230a may include a first thickness (x) that contacts one surface of the lead tab portion 150, 151 and a second thickness (y) that contacts the other surface of the lead tab portion 150, 151.

The total thickness of the first thickness (x) and the second thickness (y) may be 140 μm to 300 μm, and the thickness of the lead tab 150 with respect to the total thickness may be 200% to 500%. The first thickness (x) and the second thickness (y) may be 30 μm to 150 μm, respectively, and the total thickness of the first and second thicknesses may be provided in the above-mentioned range, so that the sealing layer 230a may be sealed uniformly surround the lead tab portion 150, 151 in relation to the thickness and width of the lead tab 150, thereby exhibiting high sealing strength, while at the same time enabling self-venting when gas is filled inside the secondary battery, thereby preventing problems such as explosion of the secondary battery from occurring.

According to an embodiment of the present invention, a pouch-type secondary battery 100 may be provided as a secondary battery pouch 200 in which the multilayer film is formed to accommodate an electrode assembly 110 having a lead tab portion 150, 151, and the secondary battery pouch 200 may be sealed together with the lead tab portion 150, 151 that is drawn out to the outside of the secondary battery pouch 200.

The secondary battery pouch 200 may be provided with a storage portion 220a that accommodates the electrode assembly 110 and a heat-fusing portion 230 that contacts at least a portion of the lead tab portion 150, 151.

The multilayer film sequentially comprises a sealing layer 230a, a metal layer 230b, and an outer layer 230c, and the secondary battery pouch 200 may comprise an upper surface 210 and a lower surface 220 composed of the multilayer film. The upper surface 210 and the lower surface 220 are composed of a pair and each includes a heat-fusing portion 230, and the heat-fusing portion 230 may be connected to the edge of the storage portion 220a.

The width of the heat-fusing portion 230 is 3 mm to 10 mm, and the lead tab portion 150, 151 may be drawn out to the outside of the secondary battery pouch through the heat-fusing portion 230. If the width of the heat-fusing portion 230 is less than 3 mm, the sealing property of the secondary battery pouch 200 is reduced, which is problematic, and if it is more than 10 mm, the volume of the portion of the secondary battery that does not exhibit capacity is unnecessarily increased, which is problematic.

The heat-fusing portion 230 and the lead tab portion 150, 151 are heat-fused, and the room temperature upper yield point, which is the sealing strength obtained by a tensile test at room temperature, is 100 N/15 mm or more, and the room temperature lower yield point is 50 N/15 mm or more, thereby improving the safety and reliability of the secondary battery.

Hereinafter, examples and comparative examples of the present invention will be described. However, the following examples are only preferred examples of the present invention, and the scope of the present invention is not limited by the following examples.

### 1. MANUFACTURING OF EXAMPLES AND COMPARATIVE EXAMPLES

### Examples 1 to 4

A multilayer film comprising an outer layer in which PET (12 μm) and Nylon (15 μm) are sequentially laminated, a metal layer (40 μm), and a sealing layer (80 μm) was formed into two layers, and a polyimide (PI) was attached as a tab film to a lead tab made of nickel. The lead tab equipped with the tab film was inserted between the multilayer films so that the tab film was interposed between the multilayer films, and heat-fusing was performed. At this time, the heat-fusing conditions were performed by applying pressure at 0.04 MPa and 190° C. for 3.0 seconds using a sealing bar having a length of 85 mm and a width of 7 mm. In the same manner, a total of four samples of Examples 1 to 4 were produced, which are shown in Table 1. The thickness of the tab film was reduced by approximately 80% during the heat-fusing process.

### Comparative Examples 1 to 12

A multilayer film comprising an outer layer in which PET (12 μm) and Nylon (15 μm) were sequentially laminated, a metal layer (40 μm), and a sealing layer (80 μm) was formed into two layers, and a polyimide (PI) was attached to a lead tab made of nickel as a tab film. The lead tab equipped with the tab film was inserted between the multilayer sheets so that the tab film was interposed between the multilayer films, and heat-fusing was performed. At this time, the heat-fusing conditions were performed by applying pressure at 0.04 MPa and 190° C. for 3.0 seconds using a sealing bar with a length of 85 mm and a width of 7 mm. A total of 12 samples of Comparative Examples 1 to 12 were produced using the same method, and these are shown in Table 1.

TABLE 1

| | | | Multi-Layer | | |
|---|---|---|---|---|---|
| | | | Film | | |
| | Metal | | (Sealing | | Tab Film (1 |
| Category | Layer | Sealing Layer | Part) | Lead Tab | Layer) |
| Examples 1 | 0.1 wt % | Polypropylene | Width (7 | Width (55 | Width (8 |
| to 4 | Fe, 99.9 | (PP) and | mm) * | mm) * | mm) * |
| | wt % Al | Ethylene- | Thickness | Thickness | Thickness |
| | | Propylene | (0.153 mm) | (0.30 mm) | (0.15 mm) |
| | | Copolymer | | | |
| Comparative | 100 wt % | Polypropylene | Width (7 | Width (55 | Width (8 |
| Examples 1 | Al | (PP) and | mm) * | mm) * | mm) * |
| to 12 | | Ethylene- | Thickness | Thickness | Thickness |
| | | Propylene | (0.153 mm) | (0.30 mm) | (0.15 mm) |
| | | Copolymer | | | |

### 2. Evaluation of Examples and Comparative Examples

For Examples 1 to 4 and Comparative Examples 1 to 12, samples with a width of 15 mm were produced, and each of them was measured with a universal material testing machine (UTM), which is a sealing strength measuring device, at a test speed of 20 mm/min and a Grip Gap of 30 mm. A tensile test was performed according to JIS Z 2241 to obtain a stress-strain curve. Then, based on this stress-strain curve, the upper yield point and the lower yield point specified in JIS Z 2241 were obtained. The upper yield point and the lower yield point obtained for each sample and their differences are shown in Tables 2 and 3. Here, Examples 1 and 2 and Comparative Examples 1 to 6 were evaluated at room temperature and are shown in Table 2, and Examples 3 and 4 and Comparative Examples 7 to 12 were evaluated at a high temperature of 60° C. and are shown in Table 3.

TABLE 2

| | Upper | Lower | Flat |
|---|---|---|---|
| | Yield | Yield | Section |
| Category (Room | Point | Point | Displacement |
| Temperature) | (N/15 mm) | (N/15 mm) | (mm) |
| Example 1 | 123 | 56 | 16~20 |
| Example 2 | 132 | 59 | 15~20 |
| Comparative Example 1 | 69 | 30 | 11~17 |
| Comparative Example 2 | 67 | 30 | 11~17 |
| Comparative Example 3 | 98 | 53 | 10~17 |
| Comparative Example 4 | 71 | 44 | 7~16 |
| Comparative Example 5 | 76 | 44 | 8~16 |
| Comparative Example 6 | 64 | 42 | 6~17 |

TABLE 3

| | Upper | Lower | Flat |
|---|---|---|---|
| | Yield | Yield | Section |
| Category (High | Point | Point | Displacement |
| Temperature) | (N/15 mm) | (N/15 mm) | (mm) |
| Example 3 | 102 | 56 | 10~18 |
| Example 4 | 102 | 51 | 14~23 |
| Comparative Example 7 | 84 | 63 | 7~14 |
| Comparative Example 8 | 82 | 62 | 6~14 |
| Comparative Example 9 | 67 | 49 | 7~13 |
| Comparative Example 10 | 70 | 53 | 6~13 |
| Comparative Example 11 | 91 | 64 | 8~16 |
| Comparative Example 12 | 91 | 62 | 7~16 |

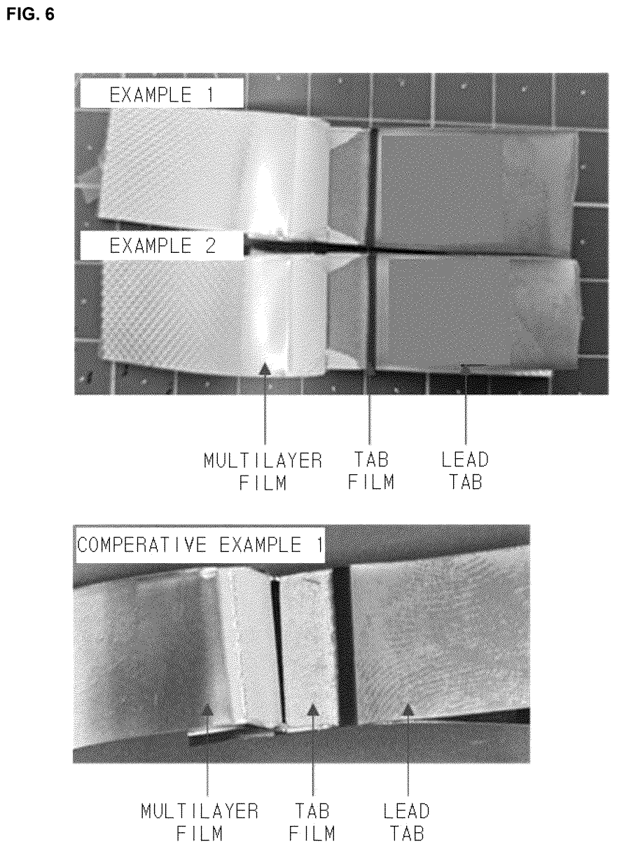

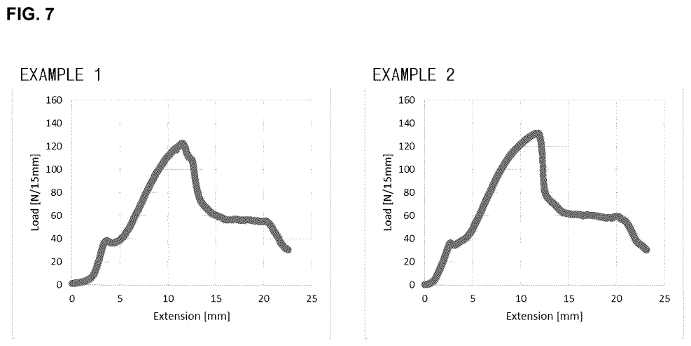

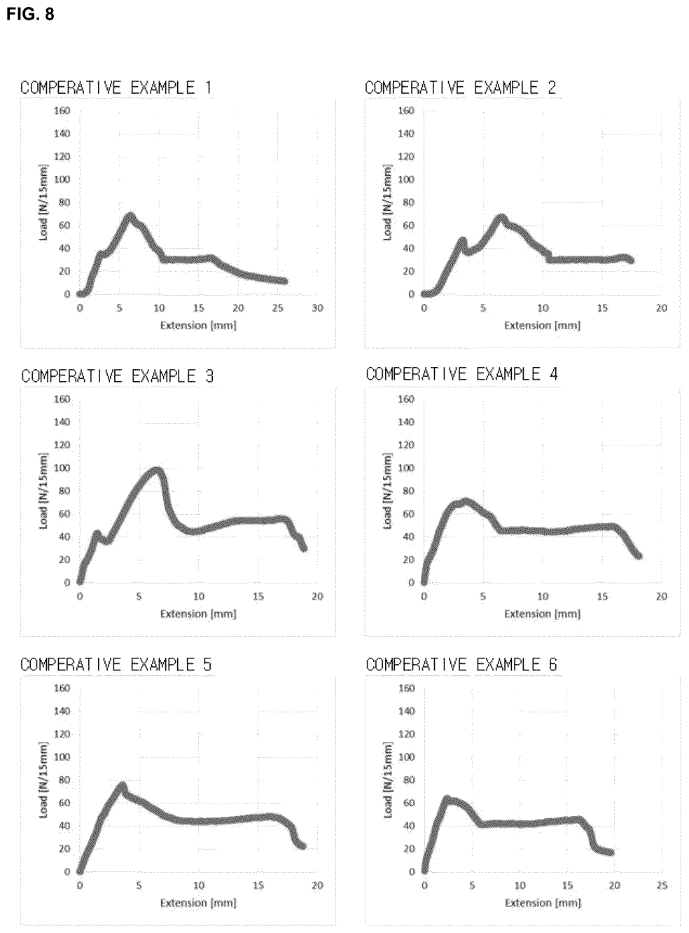

FIG. 6 is a drawing showing the peeling interface after measuring the peeling strength of Examples 1, 2 and Comparative Example 1 at room temperature. FIG. 7 is a graph showing the sealing strength of the lead tab portion and the sealing layer of Examples 1 and 2 at room temperature. FIG. 8 is a graph showing the sealing strength of the lead tab portion and the sealing layer of Comparative Examples 1 to 6 at room temperature.

Referring to Table 2 and FIGS. 6 and 7, in the case of Examples 1 and 2, the upper yield point, which is the maximum sealing strength at room temperature, was 100 N/15 mm or more, and the lower yield point in the Plateau section was 50 N/15 mm or more. On the other hand, in Comparative Examples 1 to 6, the upper yield point was less than 100 N/15 mm and the lower yield point was less than 40 N/15 mm. Compared to Examples 1 and 2, Comparative Examples 1 to 6 showed lower sealing strength between the sealing layer and the lead tab portion, and also, in Examples 1 and 2, when the lead tab portion was tensioned, it was confirmed that the sealing layer was cleanly separated from the lead tab together with the tab film, allowing self-venting. On the other hand, in Comparative Examples 1 to 6, it was confirmed that the sealing layer remained on the tab film of the lead tab portion, and that the lead tab portion and the sealing layer were not separated well after the lower yield point and were attached stickily. In other words, Comparative Examples 1 to 6 showed difficulty in self-venting, unlike Examples 1 and 2.

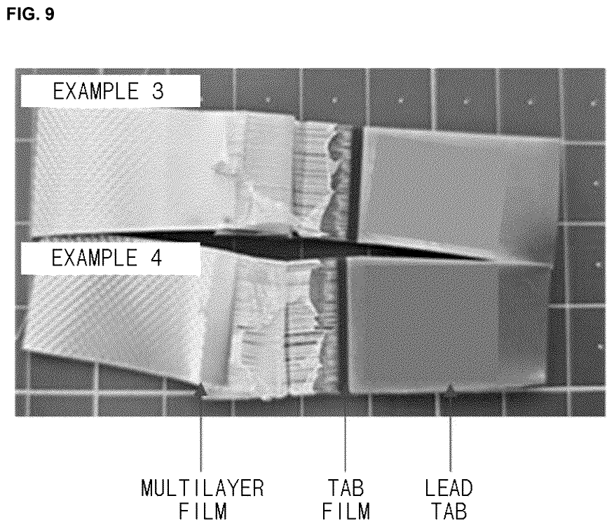

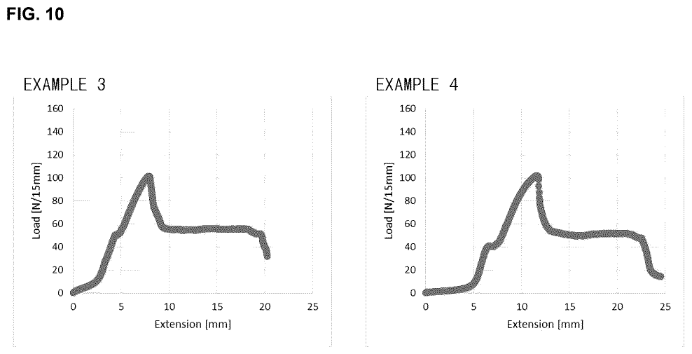

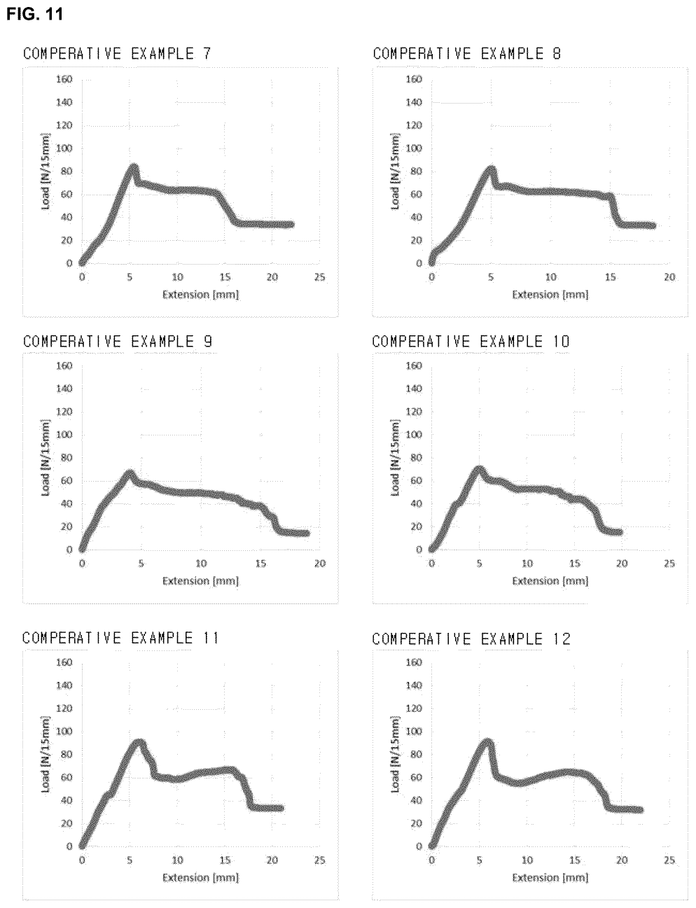

FIG. 9 is a drawing showing the peeling interface after measuring the peeling strength of Examples 3 and 4 at high temperature (60° C.). FIG. 10 is a graph showing the sealing strength of the lead tab portion and the sealing layer of Examples 3 and 4 at high temperature (60° C.). FIG. 11 is a graph showing the sealing strength of the lead tab and sealing layer of Comparative Examples 7 to 12 at high temperature (60° C.).

The sealing strength at high temperature was confirmed using Table 3 and FIGS. 10 and 11. Examples 3 and 4 showed an upper yield point of 90 N/15 mm or more and a lower yield point of 50 N/15 mm or more in the Plateau section, similar to the sealing strength at room temperature. On the other hand, Comparative Examples 7 to 12 showed an upper yield point of less than 100 N/15 mm, which is the maximum sealing strength, and a lower yield point of less than 40 N/15 mm in the Plateau section. Similar to the sealing strength evaluated at room temperature, it was confirmed that Examples 3 and 4 showed superior sealing strength and self-venting characteristics compared to Comparative Examples even at high temperatures.

Due to the high capacity of batteries, the stack-type and medium-to-large-sized cell pouch-type secondary batteries are becoming larger in area, and accordingly, high sealing properties between the lead tab and the sealing layer are required. On the other hand, since the lead tab made of metal, the tab film made of polymer material, and the sealing layer made of polymer material are bonded by materials having various properties, if the sealing properties between the interfaces are low, leakage of electrolyte, gas ingress, etc. may occur, and when a long-term cycle is performed, problems such as the sealing layer being peeled off from the lead tab, or the tab film being peeled off together with the sealing layer from the lead tab occur.

On the other hand, as described above, the multilayer film according to the present embodiment can have high sealing strength with the lead tab at room temperature and high temperature. In addition, the sealing layer according to the present embodiment is fused and sealed by completely surrounding the side portion of the lead tab, thereby providing a pouch-type secondary battery that is capable of self-venting and has high reliability and stability.

A person having ordinary skill in the art to which the present invention pertains will understand that the present invention can be implemented in other specific forms without changing the technical idea or essential characteristics thereof. Therefore, it should be understood that the embodiments described above are exemplary in all respects and not limiting. The scope of the present invention is indicated by the scope of the patent claims described below rather than the detailed description above, and all changes or modifications derived from the meaning and scope of the patent claims and their equivalent concepts should be interpreted as being included in the scope of the present invention.

### REFERENCE NUMERALS

100: Secondary battery
130: Electrode assembly
150: Lead tab
151: Tab film
200: Pouch for a secondary battery

1. A multilayer film for a secondary battery pouch housing an electrode assembly having a lead tab portion therein comprising:
an outer layer;
a metal layer; and
a sealing layer,
wherein the outer layer, the metal layer and the sealing layer are sequentially stacked,
wherein the lead tab portion comprises a lead tab and a tab film provided on at least a portion of the lead tab,
wherein the lead tab portion is heat-fused with the multilayer film for the pouch, wherein the tab film is interposed between the sealing layer and the lead tab and is heat-fused,
wherein a room temperature upper yield point, which is a sealing strength obtained by a tensile test of the heat-fused sealing layer and lead tab portion at room temperature, is 100 N/15 mm or more, and a room temperature lower yield point is 50 N/15 mm or more.

2. The multilayer film of claim 1, wherein the room temperature upper yield point is 100 N/15 mm to 180 N/15 mm,
wherein the room temperature lower yield point is 50 N/15 mm to 90 N/15 mm.

3. The multilayer film of claim 1, wherein a high temperature upper yield point, which is the maximum sealing strength of the heat-fused sealing layer and lead tab portion at 60° C., is 90 N/15 mm or more, and a high temperature lower yield point is 50 N/15 mm or more.

4. The multilayer film of claim 3, wherein the high temperature upper yield point is 90 N/15 mm to 150 N/15 mm,
wherein the high temperature lower yield point is 50 N/15 mm to 90 N/15 mm.

5. The multilayer film of claim 1, wherein a melting temperature (Tm) of the sealing layer is 80° C. to 180° C.

6. The multilayer film of claim 1, wherein the sealing layer is formed by extruding at least one of polypropylene (PP) and an ethylene-propylene copolymer,
wherein thickness of the sealing layer is 30 μm to 150 μm.

7. The multilayer film of claim 1, wherein the sealing layer contacts one side and the other side of the lead tab portion, respectively,
wherein a total contact area of the one side and the other side of the lead tab portion and the sealing layer is 25 mm² to 1000 mm².

8. The multilayer film of claim 7, wherein a heat-fusing condition of the sealing layer and the lead tab portion are performed at 3.0 sec, 0.04 MPa, and 190° C. using a sealing bar having the length of 85 mm and the width of 7 mm,
wherein the sealing strength is obtained by measuring with a sealing strength measuring device at test speed of 20 mm/min and Grip Gap of 30 mm.

9. The multilayer film of claim 7, wherein thickness of the lead tab is 300 μm to 1000 μm,
wherein width of the lead tab is 5 mm to 100 mm.

10. The multilayer film of claim 9, wherein the sealing layer comprises a first thickness in contact with one surface of the lead tab portion and a second thickness in contact with the other surface of the lead tab portion,
wherein total thickness of the first thickness and the second thickness is 140 μm to 300 μm,
wherein thickness of the lead tab with respect to the total thickness is 200% to 500%.

11. The multilayer film of claim 1, wherein the outer layer is at least one of nylon, polyethylene terephthalate (PET), polybutylene terephthalate (PBT), and polyethylene,
wherein the metal layer comprises aluminum and iron, and the iron is 0.01 wt % to 2 wt %.

12. A pouch-type secondary battery comprising a secondary battery pouch including the multilayer film according to any one of claim 1, comprising,
an electrode assembly including a positive electrode, a negative electrode, and a separator, and having at least one lead tab portion protruding outward;
a storage portion for storing the electrode assembly; and
a heat-fusing portion in contact with at least a portion of the lead tab portion.

13. The pouch-type secondary battery of claim 12, wherein the multilayer film comprises a sealing layer, a metal layer, and an outer layer,
wherein the secondary battery pouch comprises an upper surface and a lower surface made of the multilayer film,
wherein the upper surface and the lower surface are composed of a pair and each comprises a heat-fusing portion,
wherein the heat-fusing portion is connected to an edge of the storage portion.

14. The pouch-type secondary battery of claim 13, wherein the heat-fusing portion has width of 3 mm to 10 mm,
wherein the lead tab portion comprises a lead tab and a tab film provided on at least a portion of the lead tab,
wherein the lead tab portion is drawn out to an outside of the secondary battery pouch through the heat-fusing portion.

15. The pouch-type secondary battery of claim 13, wherein the heat-fusing portion and the lead tab portion are heat-fused,
wherein a room temperature upper yield point, which is a sealing strength obtained by a tensile test at room temperature, is 100 N/15 mm or more, and a room temperature lower yield point is 50 N/15 mm or more.

16. A pouch-type secondary battery comprising a secondary battery pouch including the multilayer film according to any one of claim 2, comprising,
an electrode assembly including a positive electrode, a negative electrode, and a separator, and having at least one lead tab portion protruding outward;
a storage portion for storing the electrode assembly; and
a heat-fusing portion in contact with at least a portion of the lead tab portion.

17. A pouch-type secondary battery comprising a secondary battery pouch including the multilayer film according to any one of claim 3, comprising,
an electrode assembly including a positive electrode, a negative electrode, and a separator, and having at least one lead tab portion protruding outward;
a storage portion for storing the electrode assembly; and
a heat-fusing portion in contact with at least a portion of the lead tab portion.

18. A pouch-type secondary battery comprising a secondary battery pouch including the multilayer film according to any one of claim 4, comprising,
an electrode assembly including a positive electrode, a negative electrode, and a separator, and having at least one lead tab portion protruding outward;
a storage portion for storing the electrode assembly; and
a heat-fusing portion in contact with at least a portion of the lead tab portion.

19. A pouch-type secondary battery comprising a secondary battery pouch including the multilayer film according to any one of claim 5, comprising,
an electrode assembly including a positive electrode, a negative electrode, and a separator, and having at least one lead tab portion protruding outward;
a storage portion for storing the electrode assembly; and
a heat-fusing portion in contact with at least a portion of the lead tab portion.

20. A pouch-type secondary battery comprising a secondary battery pouch including the multilayer film according to any one of claim 6, comprising,
an electrode assembly including a positive electrode, a negative electrode, and a separator, and having at least one lead tab portion protruding outward;
a storage portion for storing the electrode assembly; and
a heat-fusing portion in contact with at least a portion of the lead tab portion.
